(19) United States
(12) Patent Application Publication
(10) Pub. No.: US 2026/0066540 A1
(43) Pub. Date: Mar. 5, 2026

(54) NEAR-FIELD COMMUNICATION (NFC) ANTENNA DESIGNED FOR ELECTROSTATIC DISCHARGE (ESD) PROTECTION

(71) Applicant: STMicroelectronics International N.V., Geneva (CH)

(72) Inventor: Liqing WU, Shenzhen (CN)

(21) Appl. No.: 19/291,025

(22) Filed: Aug. 5, 2025

(30) Foreign Application Priority Data
Aug. 28, 2024 (CN) 202411196944.0

(51) Int. Cl. H01Q 7/00; H01Q 1/22; H01Q 1/50

(52) U.S. Cl. CPC H01Q 7/00; H01Q 1/22; H01Q 1/50

(57) ABSTRACT

An example NFC communication device, a mobile electronic device comprising an NFC communication device, and a method of manufacturing an NFC communication device protecting against ESD are provided. The example NFC communication device includes NFC control circuitry, an NFC loop antenna, and an electrical ground. The NFC control circuitry includes an NFC controller and impedance matching circuitry. The NFC loop antenna is electrically connected to the NFC controller and the impedance matching circuitry. The electrical ground is electrically connected to an inductance characteristics center of the NFC loop antenna, wherein the electrical ground provides a discharge path for an electrostatic discharge received at the NFC loop antenna.

### CROSS-REFERENCE TO RELATED APPLICATIONS

This application claims the benefit of Chinese Patent Application No. 202411196944.0, filed Aug. 28, 2024, the entire contents of which is hereby incorporated by reference in its entirety.

### TECHNOLOGICAL FIELD

Embodiments of the present disclosure relate generally to near-field communication (NFC) devices, and more particularly, to electrostatic discharge (ESD) protection on NFC devices.

### BACKGROUND

NFC is a short-range wireless communication technology that enables communication between NFC enabled devices in close proximity. NFC may be utilized to facilitate authenticating credit cards, enabling physical access, transferring files, enabling other communication links, and so on. In general, NFC enabled devices transmit and receive short-range communications through an NFC antenna. NFC antennas generally operate at low frequencies (e.g., 13.56 MHz) with large wavelengths, on small devices. Thus, NFC devices utilize NFC antennas to generate a magnetic field and initiate magnetic coupling between two NFC devices in close proximity.

Applicant has identified many technical challenges and difficulties associated with ESD protection on NFC devices. Through applied effort, ingenuity, and innovation, Applicant has solved problems related to ESD protection on NFC devices by developing solutions embodied in the present disclosure, which are described in detail below.

### BRIEF SUMMARY

Various embodiments are directed to an example NFC communication device, a mobile electronic device comprising an NFC communication device, and a method of manufacturing an NFC communication device protecting against ESD. An example NFC communication device is provided. The example NFC communication device comprises NFC control circuitry, an NFC loop antenna, and an electrical ground. The NFC control circuitry comprises an NFC controller and impedance matching circuitry. The NFC loop antenna electrically connected to the NFC controller and the impedance matching circuitry. The electrical ground electrically connected to an inductance characteristics center of the NFC loop antenna, wherein the electrical ground provides a discharge path for an electrostatic discharge received at the NFC loop antenna.

In some embodiments, the NFC loop antenna comprises a conductive element comprising a first end terminating at a first feed point and a second end terminating at a second feed point.

In some embodiments, a first inductance along the conductive element between the first feed point and the inductance characteristics center is substantially equivalent to a second inductance along the conductive element between the second feed point and the inductance characteristics center.

In some embodiments, the first feed point is electrically connected to a first transmission line of the impedance matching circuitry, and the second feed point is electrically connected to a second transmission line of the impedance matching circuitry.

In some embodiments, a loop ground impedance between any point on the NFC loop antenna and the electrical ground through the inductance characteristics center is less than an NFC control circuitry ground impedance between the point and the electrical ground through the NFC control circuitry.

In some embodiments, the impedance matching circuitry comprises one or more electrical components configured to match the impedance of the NFC loop antenna.

In some embodiments, the impedance matching circuitry further includes frequency filtering circuitry on the first transmission line and the second transmission line.

In some embodiments, the frequency filtering circuitry comprises at least an inductor and a capacitor connected in series to the electrical ground.

In some embodiments, the impedance matching circuitry further comprises a first receive line electrically connected to the first feed point and the NFC controller; and a second receive line electrically connected to the second feed point and the NFC controller.

In some embodiments, the inductance characteristics center of the NFC loop antenna is electrically connected to the electrical ground by a grounded pogo pin.

In some embodiments, the inductance characteristics center of the NFC loop antenna is electrically connected to the electrical ground by a grounded screw.

In some embodiments, the NFC communication device is configured to transmit and receive NFC signals.

A mobile electronic device is further provided. In some embodiments, the mobile electronic device may comprise a main board and an NFC communication device. The main board comprises an electrical ground. The NFC communication device comprises NFC control circuitry and an NFC loop antenna. The NFC control circuitry, comprising an NFC controller and impedance matching circuitry. The NFC loop antenna electrically connected to the NFC controller and the impedance matching circuitry, wherein the electrical ground is electrically connected to an inductance characteristics center of the NFC loop antenna, and wherein the electrical ground provides a discharge path for an electrostatic discharge (ESD) received at the NFC loop antenna.

In some embodiments, the NFC loop antenna comprises a conductive element comprising a first end terminating at a first feed point and a second end terminating at a second feed point.

In some embodiments, a first inductance along the conductive element between the first feed point and the inductance characteristics center is substantially equivalent to a second inductance along the conductive element between the second feed point and the inductance characteristics center.

In some embodiments, the first feed point is electrically connected to a first transmission line of the impedance matching circuitry, and the second feed point is electrically connected to a second transmission line of the impedance matching circuitry.

In some embodiments, a loop ground impedance between any point on the NFC loop antenna and the electrical ground through the inductance characteristics center is less than an NFC control circuitry ground impedance between the point and the electrical ground through the NFC control circuitry.

In some embodiments, the main board further comprising a grounded pogo pin electrically connected to the electrical ground, wherein the inductance characteristics center of the NFC loop antenna is electrically connected to the electrical ground by the grounded pogo pin.

In some embodiments, the main board further comprising a grounded screw electrically connected to the electrical ground, wherein the inductance characteristics center of the NFC loop antenna is electrically connected to the electrical ground by the grounded screw.

A method of manufacturing an NFC communication device is also provided. In some embodiments, the method of manufacturing comprises providing NFC control circuitry, comprising an NFC controller and impedance matching circuitry. Providing an NFC loop antenna. Electrically connecting the NFC loop antenna to the NFC controller and the impedance matching circuitry. Providing an electrical ground. Determining an inductance characteristics center of the NFC loop antenna. Providing a discharge path for an electrostatic discharge (ESD) received at the NFC loop antenna, by electrically connecting the inductance characteristics center of the NFC loop antenna to the electrical ground.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a circuit-level diagram of an example NFC communication device.

FIG. 2 illustrates a block diagram of an example NFC communication device in accordance with an example embodiment of the present disclosure.

FIG. 3 illustrates a circuit-level diagram of an example NFC communication device in accordance with an example embodiment of the present disclosure.

FIG. 4 illustrates an example ESD discharge path on an NFC loop antenna in accordance with an example embodiment of the present disclosure.

FIG. 5 illustrates an example mobile electronic device comprising an NFC communication device in accordance with an example embodiment of the present disclosure.

FIG. 6A-FIG. 6B illustrate an example NFC loop antenna configured to interface with a grounded pogo pin in accordance with an example embodiment of the present disclosure.

FIG. 7A-FIG. 7B illustrate an example NFC loop antenna configured to interface with a grounded screw in accordance with an example embodiment of the present disclosure.

FIG. 8 depicts an example method of manufacturing an NFC communication device comprising an NFC loop antenna in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with protecting against ESD received at an NFC communication device. As understood by those of skill in the field to which the present disclosure pertains, there are numerous example scenarios in which protection against ESD may be desired on an NFC communication device.

In general, NFC is a short-range wireless communication technology that enables communication between NFC enabled devices in close proximity. NFC may be utilized to facilitate authenticating credit cards, enabling physical access, transferring files, enabling other communication links, and so on. NFC enabled devices transmit and receive short-range communications through an NFC antenna. NFC antennas generally operate at low frequencies (e.g., 13.56 MHz) with large wavelengths, on small devices. Thus, NFC devices utilize NFC antennas to generate a magnetic field and initiate magnetic coupling between two NFC devices in close proximity.

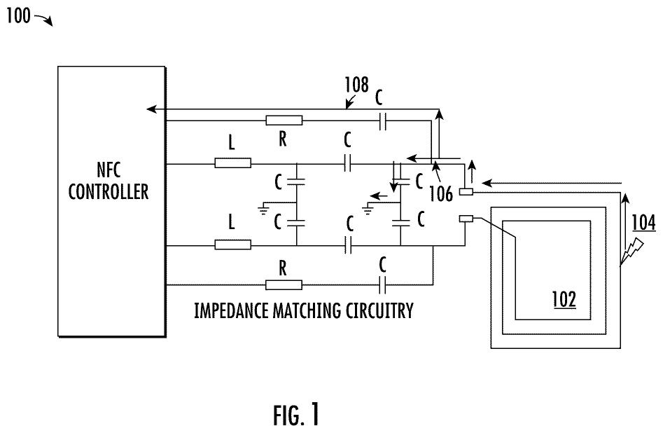

Referring now to FIG. 1, an example NFC communication device 100 is provided. As shown in FIG. 1, the example NFC communication device 100 includes an NFC controller integrated circuit (IC) configured to encode and generate NFC signals during NFC transmissions and/or receive and decode a received NFC signal. As further depicted in FIG. 1, an NFC antenna 102 is electrically connected to a first feed point and a second feed point of impedance matching circuitry providing an interface to the NFC controller.

As depicted in FIG. 1, the example NFC communication device 100 includes an NFC antenna 102 comprising a plurality of conductive loops. An NFC antenna 102 comprises a loop or coil of an electrical conductor, for example, a wire, tubing, or other similar material. An electrical signal generated by the NFC controller causes the NFC antenna 102 to radiate at a particular frequency, for example, 13.56 megahertz. The electrical signal in the NFC antenna 102 causes a magnetic field with a resonant frequency to be generated. The magnetic field may induce a current in a nearby NFC receiving apparatus in an instance in which the receiving apparatus and the NFC communication device 100 are brought within close proximity.

As further depicted in FIG. 1, the example NFC communication device 100 includes impedance matching circuitry. Impedance matching circuitry includes various electrical components on the transmission and receive lines of the NFC communication device 100. The electrical components of the impedance matching circuitry filter signal noise and match the impedance of the NFC antenna 102. Matching the impedance of the NFC antenna 102 improves the operating efficiency of the NFC communication device 100.

Many NFC communication devices 100 are subject to strict size requirements. In order to induce a sufficient magnetic field for data and/or power transfer, an NFC antenna 102 is often designed to occupy as large of a surface area as available. As such, as further depicted in FIG. 1, the NFC communication device 100 may be exposed to spikes in voltage and/or current through electrostatic discharge (ESD) 104. ESD 104 may be received by an NFC antenna 102 when an oppositely charged object is brought in close proximity to the NFC antenna 102. ESD 104 may be introduced by touching an NFC antenna 102, placing it near an ESD generating device (e.g., dryer), or through another source. The spikes in voltage and current may be damaging to the impedance matching circuitry of the NFC communication device 100, or even the NFC controller. As shown in FIG. 1, the ESD 104 pulse will take the path of least impedance (or resistance) to electrical ground. In some embodiments, the path of least impedance passes through one or more electrical components of the impedance matching circuitry, for example discharge path 106. The spike in voltage and/or current may be damaging to the electrical components of the impedance matching circuitry. Damage to the electrical components of the impedance matching circuitry may lead to decreased performance of the NFC communication device 100 or even failure.

In some embodiments, as shown in FIG. 1, the ESD 104 pulse may follow a discharge path that passes through the NFC controller, for example discharge path 108. The spike in voltage and/or current may be damaging to the electrical components of the NFC controller. Damage to the NFC controller may also lead to decreased performance of the NFC communication device 100 or even failure.

In some examples, transient voltage suppressor (TVS) diodes may be placed within the impedance matching circuitry at the antenna feed points to protect against ESD 104 pulses entering the impedance matching circuitry of the NFC communication device 100. Such examples may enable a path to ground proximate the antenna feed points in an instance in which the voltage in the impedance matching circuitry exceeds a certain threshold voltage determined by the TVS diodes. Utilizing TVS diodes within the impedance matching circuitry may also have drawbacks. For example, in an instance in which the output voltage on the antenna exceeds the threshold voltage of the TVS diodes, one or more of the TVS diodes may be triggered, enabling a path to electrical ground. Triggering the TVS diodes during normal operation may adversely affect the performance of the NFC communication device 100. Further, if TVS diodes are selected such that the antenna voltage is unlikely to trigger the TVS diodes during normal operation, discharging speeds may be impacted because the electric charge remains on the NFC antenna 102 and impedance matching circuitry for an extended period of time. In addition, TVS diodes may be expensive to include on NFC communication devices 100.

The various example embodiments described herein utilize various techniques to protect against ESD received at an NFC communication device. For example, in some embodiments, an inductance characteristics center of an NFC loop antenna may be determined. The inductance characteristics center of an NFC loop antenna represents the point on the conductive element at which the inductance between the inductance characteristics center and the first feed point is equivalent to the inductance between the inductance characteristics center and the second feed point. Once the inductance characteristics center of the NFC loop antenna is determined, the inductance characteristics center is electrically connected to an electrical ground. During operation of the NFC loop antenna, the inductance characteristics center acts as a dummy ground. Thus, the voltage at such a point is at or near 0 volts. By electrically connecting the inductance characteristics center of the NFC loop antenna to an electrical ground, the performance of the NFC loop antenna is unaffected.

However, electrically connecting the inductance characteristics center to an electrical ground may provide a discharge path for ESD received at the NFC loop antenna. Since there is no capacitor, or other high impedance electrical component on the inductance characteristics center grounding line, the path to electrical ground through the inductance characteristics center may comprise the discharge path with the least impedance for any ESD received at the NFC loop antenna. Thus, ESD received at the NFC loop antenna may pass to electrical ground through the grounding line at the inductance characteristics center without passing through the electrical components comprising the impedance matching circuitry or the NFC controller.

As a result of the herein described example embodiments and in some examples, the performance of an NFC communication device may be greatly improved. In addition, costly ESD protection mechanisms, such as TVS diodes may be avoided.

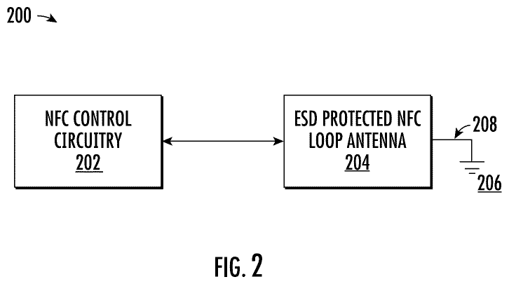

Referring now to FIG. 2, an example NFC communication module 200 in accordance with an example embodiment of the present disclosure is provided. As depicted in FIG. 2, the example NFC communication module 200 includes NFC control circuitry 202 electrically connected to an ESD protected NFC loop antenna 204. As further depicted in FIG. 2, the ESD protected NFC loop antenna 204 is electrically connected to an electrical ground 206 by a grounding line 208.

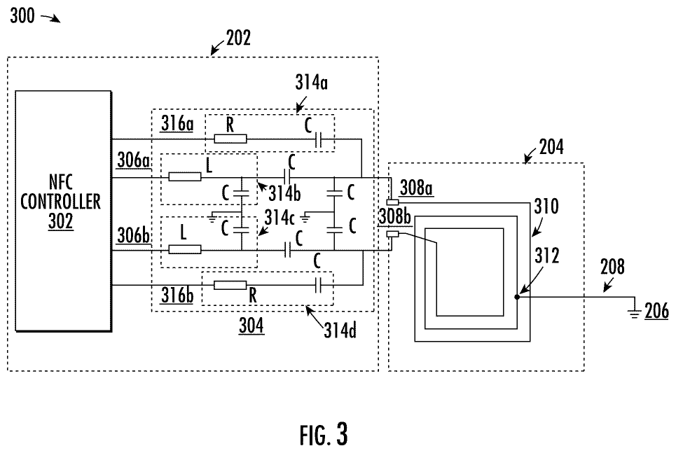

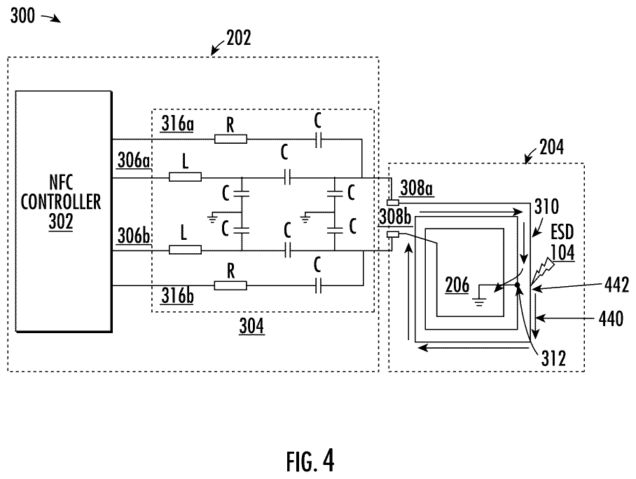

As depicted in FIG. 2, the example NFC communication module 200 includes NFC control circuitry 202. NFC control circuitry 202 comprises any circuitry comprising hardware and/or software configured to generate and/or decode NFC signals. During NFC signal transmission, the NFC control circuitry may generate an NFC signal, encoding any data to be transmitted. The NFC signal causes the ESD protected NFC loop antenna 204 to radiate a magnetic field, such that a second NFC device or tag may receive the transmitted data encoded in the magnetic field. In some embodiments, the magnetic field generated by the NFC communication module 200 may induce a current in the receiving NFC device or tag. Such functionality enables communication with unpowered NFC devices. During NFC signal reception, the NFC control circuitry receives data encoded in a magnetic field received at the ESD protected NFC loop antenna 204. The NFC control circuitry 202 is configured to decode the NFC signal and perform operations based on the decoded data. In some embodiments, the NFC control circuitry 202 may comprise an NFC controller and impedance matching circuitry as described in relation to FIG. 3-FIG. 4.

As further depicted in FIG. 2, the example NFC communication module 200 includes an ESD protected NFC loop antenna 204. An ESD protected NFC loop antenna 204 comprises a conductive element forming one or more loops or coils and configured to generate and/or receive a magnetic field corresponding to an NFC signal. In general, an ESD protected NFC loop antenna 204 is configured to operated at or around 13.56 megahertz, or at a wavelength of 22.12 meters. However, the electronic devices comprising such ESD protected NFC loop antennas 204 generally have significantly limited size constraints. Thus, an ESD protected NFC loop antenna 204 may be configured to occupy as much area is available within an electronic device to generate a magnetic field that may be received by one or more nearby NFC enabled devices.

As described in relation to FIG. 1, ESD protected NFC loop antennas 204 may be susceptible to reception of ESD at the conductive element of the ESD protected NFC loop antenna 204. As depicted in FIG. 2, an ESD protected NFC loop antenna 204 includes a conductive grounding line 208 electrically connecting the inductance characteristics center of the ESD protected NFC loop antenna 204 to an electrical ground 206.

The inductance characteristics center of an ESD protected NFC loop antenna 204 is the point on the conductive element of the ESD protected NFC loop antenna 204 at which the inductance between the inductance characteristics center and a first end of the conductive element of the ESD protected NFC loop antenna 204 is equal to the inductance between the inductance characteristics center and a second end of the conductive element of the ESD protected NFC loop antenna 204. By electrically connecting the grounding line 208 at the inductance characteristics center of the ESD protected NFC loop antenna 204, the transmission and reception of NFC signals at the ESD protected NFC loop antenna 204 is unaffected. The transmission and reception of NFC signals is unaffected because during operation of the ESD protected NFC loop antenna 204, the inductance characteristics center acts as a dummy ground, wherein the voltage is at or near 0 volts. Thus, during operation of the ESD protected NFC loop antenna 204 no voltage is lost through the grounding line 208. However, in an event in which ESD is received at the ESD protected NFC loop antenna 204, the grounding line 208 provides a low impedance discharge path to electrical ground 206. By placing a grounding line 208 at the inductance characteristics center of the ESD protected NFC loop antenna 204, ESD received at any point on the conductive element of the ESD protected NFC loop antenna 204 has a low impedance discharge path to electrical ground 206 through the grounding line 208. The grounding line 208 to electrical ground 206 provides an alternative, lower impedance discharge path, preventing damage to electrical components of the NFC control circuitry 202.

Referring now to FIG. 3, an example embodiment of an NFC communication module 300 is provided. As depicted in FIG. 3, the example NFC communication module 300 includes NFC control circuitry 202 electrically connected to an ESD protected NFC loop antenna 204 at a first feed point 308a and a second feed point 308b. As further depicted in FIG. 3, the NFC control circuitry 202 includes an NFC controller 302 electrically connected to impedance matching circuitry 304. The inductance characteristics center 312 of the ESD protected NFC loop antenna 204 is further electrically connected to an electrical ground 206 with a grounding line 208.

As depicted in FIG. 3, the example NFC control circuitry 202 includes an NFC controller 302. An NFC controller 302 comprises any circuitry including hardware and/or software configured to perform operations necessary to transmit and receive encoded NFC signals. For example, in support of NFC signal transmission, the NFC controller 302 may determine an encoding for the data to be transmitted and manipulate the electromagnetic signal on the first transmission line 306a and the second transmission line 306b to generate a magnetic field at the ESD protected NFC loop antenna 204 encoding the data. Similarly, the NFC controller 302 may be configured to receive encoded NFC signals at the first receive line 316a and the second receive line 316b and perform operations to decode the data encoded in the magnetic field received at the ESD protected NFC loop antenna 204.

In some embodiments, the NFC controller 302 includes a processor, input/output circuitry, data storage media, communications circuitry, and the like to execute and perform the operations described herein.

As further depicted in FIG. 3, the NFC control circuitry 202 further includes impedance matching circuitry 304. Impedance matching circuitry 304 comprises any circuitry including hardware and/or software configured to match the impedance of the corresponding ESD protected NFC loop antenna 204 on each of the NFC transmission lines (e.g., first transmission line 306a, second transmission line 306b). By matching the impedance of the ESD protected NFC loop antenna 204, the magnetic field generated by the ESD protected NFC loop antenna 204 based on the NFC signals provided by the NFC controller 302 may be maximized. Impedance matching circuitry 304 may include various passive electrical components, for example, capacitors as depicted in FIG. 3.

As further depicted in FIG. 3, the impedance matching circuitry 304 includes frequency filtering circuitry 314a-314d, on each of the NFC transmission lines (e.g., first transmission line 306a, second transmission line 306b) and each of the NFC receive lines (e.g., first receive line 316a, second receive line 316b). Frequency filtering circuitry 314a-314d comprises any circuitry configured to damp or minimize specific frequency ranges from the NFC signals. Frequency filtering circuitry 314a-314d may include various electrical components, such as resistors (R), inductors (L) and capacitors (C).

As further depicted in FIG. 3, the example ESD protected NFC loop antenna 204 includes a conductive element 310 comprising a plurality of loops and/or coils. During transmission, the conductive element 310 is configured to receive an oscillating electromagnetic signal, corresponding to the NFC signal generated by the NFC controller 302, at the first feed point 308a and the second feed point 308b. Similarly, during reception of an NFC signal, the ESD protected NFC loop antenna 204 is configured to generate an oscillating electromagnetic signal at the first feed point 308a and the second feed point 308b corresponding to an NFC signal received at the looped conductive element 310.

The conductive element 310 of the ESD protected NFC loop antenna 204 may comprise any conductive material including copper, tin, aluminum, silver, gold, etc. and may be formed into conductive wire, conductive tubing, conductive traces, and so on. The conductive element 310 comprises a first end electrically connected to the first feed point 308a and a second end electrically connected to the second feed point 308b. The conductive element 310 may be formed into a plurality of coils to facilitate the generation of a magnetic field to transmit data and/or power to a nearby device.

The conductive element 310 may further include an inductance characteristics center 312. The inductance characteristics center 312 is the point on the conductive element 310 at which the inductance (e.g., first inductance) between the inductance characteristics center 312 and the first end of the conductive element 310 is equal to the inductance (e.g., second inductance) between the inductance characteristics center 312 and the second end of the conductive element 310.

The inductance characteristics center may be determined by positioning an inductance measurement device at various points on the conductive element 310 of the ESD protected NFC loop antenna 204 and determining the inductance between the first end (e.g., first inductance) and the inductance between the second end (e.g., second inductance). The point at which the first inductance and the second inductance are equal, within a certain tolerance, is the inductance characteristics center 312. In some embodiments, the inductance characteristics center 312 may correspond with the point of the conductive element 310 equidistant from the first end and the second end along the length of the conductive element 310 (e.g., the physical center of the conductive element 310). However, due to variance in the conductive material comprising the conductive element 310 and various other factors, the inductance characteristics center 312 may not be at the physical center of the conductive element 310. In some embodiments, the inductance characteristics center 312 may be determined using a simulation tool.

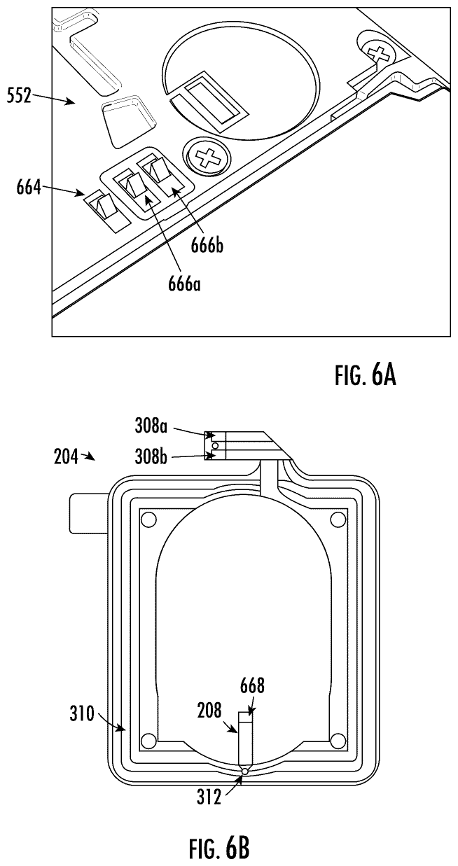

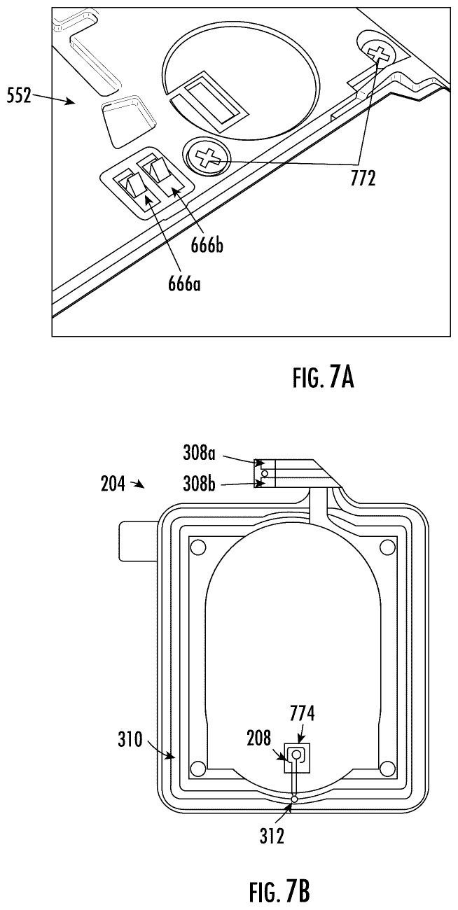

As further depicted in FIG. 3, a grounding line 208 is attached to the ESD protected NFC loop antenna 204 at the inductance characteristics center 312 of the conductive element 310. A grounding line 208 comprises any conductive material configured to attach to the inductance characteristics center 312 of the conductive element 310 and an electrical ground 206. In some embodiments, the electrical ground 206 may be a portion of a mobile electronic device, for example a main board electrical ground. Mechanisms for attaching to a main board electrical ground are further described in relation to FIG. 6A-FIG. 7B.

Referring now to FIG. 4, an example discharge path 440 on an example NFC communication module 300 comprising an ESD protected NFC loop antenna 204 is provided.

In an instance in which ESD 104 is introduced into an NFC communication module 300, the voltage and/or current surge generated by the ESD 104 will follow the path of least impedance to electrical ground. In some previous examples, the path of least impedance to electrical ground was through the impedance matching circuitry 304 and/or NFC controller 302. The high voltage and/or current pulse may damage electrical components encountered in the path to electrical ground. By attaching the inductance characteristics center 312 of the ESD protected NFC loop antenna 204 to the electrical ground 206, a low impedance path to ground (e.g., discharge path 440) is created. Thus, in an instance in which ESD 104 is introduced into the NFC communication module 300 at the ESD protected NFC loop antenna 204, the high voltage and/or current pulse follows a discharge path through the inductance characteristics center 312 of the conductive element 310 to the electrical ground 206. The discharge path through the inductance characteristics center 312 is taken because the impedance between the ESD 104 entry point and electrical ground 206 through the inductance characteristics center 312 (e.g., loop ground impedance) is less than the impedance between the ESD 104 entry point and electrical ground through the NFC control circuitry 202 (e.g., NFC controller circuit ground impedance).

For example, in an instance in which ESD 104 is introduced at a contact point 442 on the conductive element 310 of the ESD protected NFC loop antenna 204, the loop ground impedance from the contact point 442 to the electrical ground 206 through the inductance characteristics center 312 is less than the NFC controller circuit ground impedance through the first feed point 308a and through one or more capacitors in the NFC control circuitry 202. The loop ground impedance is less at least in part due to the fact that there are no capacitors or other high impedance electrical components between the contact point 442 and the electrical ground 206. Thus, the ESD 104 follows the discharge path 440 to the electrical ground 206. By following the discharge path 440, no electrical components of the NFC control circuitry, including the impedance matching circuitry 304 and the NFC controller 302, are damaged.

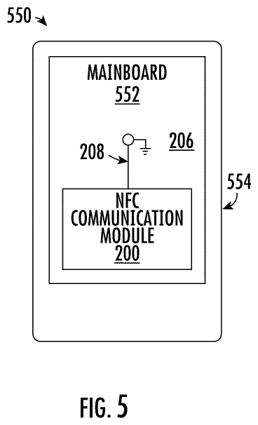

Referring now to FIG. 5, an example mobile electronic device 550 is provided. As depicted in FIG. 5, the example mobile electronic device 550 includes a main board 552 and an NFC communication module 200 within a housing 554. The main board 552 includes an electrical ground 206 and the NFC communication module 200 is electrically connected to the electrical ground 206 by a grounding line 208.

As depicted in FIG. 5, the main board 552 of the example mobile electronic device 550 provides an electrical ground. The main board 552 of the mobile electronic device 550 is the structure comprising all of the essential parts and components of the mobile electronic device 550. For example, a central processing unit (CPU), power integrated circuit, storage, random access memory (RAM), wireless communication devices, network cards, NFC control circuitry (e.g., NFC control circuitry 202), and so on. In addition, peripheral components may be connected to the main board 552 through external ports. In some embodiments, the main board 552 may comprise a printed circuit board (PCB). In order to operate, a main board 552 also includes an electrical ground 206. In some embodiments, the electrical ground 206 may be established by contact to a surface of the mobile electronic device 550 housing 554. For example, the main board 552 may include a grounding screw configured to contact a surface of the housing 554. The main board 552 may include various conductive traces to establish electrical contact with the electrical ground 206 and provide the electrical ground 206 to the various electrical components of the main board 552.

As further depicted in FIG. 5, the NFC communication module 200 may access the electrical ground 206 on the main board 552 of the mobile electronic device 550. For example, the conductive grounding line 208 of the NFC communication module 200 may be electrically connected to the electrical ground 206 of the main board 552. The grounding line 208 establishes an electrical connection between the inductance characteristics center of the ESD protected NFC loop antenna and the electrical ground 206 of the main board 552. FIG. 6A-FIG. 7B depict example embodiments utilized to electrically connect the inductance characteristics center of the ESD protected NFC loop antenna to the electrical ground 206 of the main board 552.

Referring now to FIG. 6A-FIG. 6B, an example grounding mechanism utilizing a grounded pogo pin 664 for electrically connecting the inductance characteristics center 312 of a conductive element 310 of an ESD protected NFC loop antenna 204 to an electrical ground is provided.

As depicted in FIG. 6A, the example main board 552 includes a plurality of feed point connectors 666a-666b and a grounded pogo pin 664.

As depicted in FIG. 6B, the example ESD protected NFC loop antenna 204 includes a conductive element 310 having a first end terminating at the first feed point 308a and a second end terminating at the second feed point 308b. In addition, a grounding line 208 is configured to electrically connect the inductance characteristics center 312 of the conductive element 310 to a conductive pad 668.

The feed point connectors 666a, 666b depicted in FIG. 6A comprise pogo pins configured to establish an electrical connection between the main board 552 and the first feed point 308a and the second feed point 308b of the ESD protected NFC loop antenna 204, for example, as depicted in FIG. 6B. Specifically, in some embodiments, the feed point connectors 666a, 666b provide an electrical connection to the transmission lines (e.g., first transmission line 306a, second transmission line 306b) and the receive lines (e.g., first receive line 316a, second receive line 316b). In such an embodiment NFC signals are transmitted to and received from the ESD protected NFC loop antenna 204 through the feed point connectors 666a, 666b.

As further depicted in FIG. 6A, the main board 552 includes a grounded pogo pin 664. The grounded pogo pin 664 is configured to interface with the grounding line 208 providing an electrical connection to the inductance characteristics center 312 of the ESD protected NFC loop antenna 204. For example, the grounded pogo pin 664 may be configured to contact the conductive pad 668 of the ESD protected NFC loop antenna 204 as depicted in FIG. 6B. Although depicted proximate the feed point connectors 666a, 666b in FIG. 6A, the grounded pogo pin 664 may be positioned anywhere within a mobile electronic device to interface with a conductive pad 668 of the ESD protected NFC loop antenna 204.

Referring now to FIG. 7A-FIG. 7B, an example grounding mechanism utilizing a grounded screw 772 for electrically connecting the inductance characteristics center 312 of a conductive element 310 of an ESD protected NFC loop antenna 204 to an electrical ground is provided.

As depicted in FIG. 7A, the example main board 552 includes a plurality of feed point connectors 666a-666b and grounded screws 772.

As depicted in FIG. 7B, the example ESD protected NFC loop antenna 204 includes a conductive element 310 having a first end terminating at the first feed point 308a and a second end terminating at the second feed point 308b. In addition, a grounding line 208 is configured to electrically connect the inductance characteristics center 312 of the conductive element 310 to a conductive hole 774.

As depicted in FIG. 7A, the main board 552 includes a plurality of grounded screws 772. The grounded screws 772 comprise a conductive material and are configured to contact an electrical ground. For example, a grounded screw 772 may be configured to contact a portion of the housing of a mobile electronic device. Any conductive element brought into contact with a grounded screw 772 is electrically connected to an electrical ground.

The conductive hole 774 of FIG. 7B is brought into contact with one or more grounded screws 772 to electrically connect the inductance characteristics center 312 of the ESD protected NFC loop antenna 204 to an electrical ground. For example, the grounded screw 772 may be screwed through the conductive hole 774.

As depicted in FIG. 6B and FIG. 7B, the conductive element 310 of the ESD protected NFC loop antenna 204 comprises a conductive trace of varying widths. In some embodiments, the inductance characteristics center 312 may correspond with a portion of the conductive element 310 at which the conductive element 310 narrows.

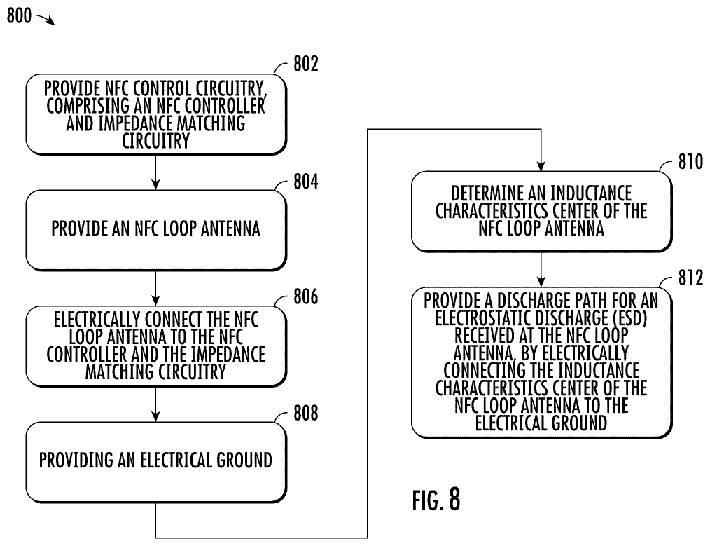

Referring now to FIG. 8, an example method of manufacturing an NFC communication module (e.g., NFC communication module 200, 300) within an NFC communication device comprising an ESD protected NFC loop antenna (e.g., ESD protected NFC loop antenna 204) is provided. At block 802, NFC control circuitry (e.g., NFC control circuitry 202), comprising an NFC controller (e.g., NFC controller 302) and impedance matching circuitry (e.g., impedance matching circuitry 304) is provided.

At block 804, an NFC loop antenna is provided. An NFC loop antenna comprises a conductive element (e.g., conductive element 310) having a first end a second end, the conductive element forming one or more loops or coils.

At block 806, the NFC loop antenna is electrically connected to the NFC controller and the impedance matching circuitry. For example, the impedance matching circuitry may include a first feed point (e.g., first feed point 308a) and a second feed point (e.g., second feed point 308b) configured to connect to the first end and the second end of the conductive element of the NFC loop antenna.

At block 808, an electrical ground (e.g., electrical ground 206) is provided. In some embodiments, the electrical ground may be provided by the main board (e.g., main board 552) of a mobile electronic device (e.g., mobile electronic device 550). For example, the electrical ground may be established by contacting a portion of the housing (e.g., housing 554) of the mobile electronic device with a conductive material. Any conductive material electrically connected to the electrical ground is grounded.

At block 810, an inductance characteristics center (e.g., inductance characteristics center 312) of the NFC loop antenna is determined. The inductance characteristics center is the point on the conductive element at which the inductance (e.g., first inductance) between the inductance characteristics center and the first end of the conductive element is equal to the inductance (e.g., second inductance) between the inductance characteristics center and the second end of the conductive element.

The inductance characteristics center may be determined by positioning an inductance measurement device at various points on the conductive element of the ESD protected NFC loop antenna and determining the inductance between the first end (e.g., first inductance) and the inductance between the second end (e.g., second inductance). The point at which the first inductance and the second inductance are equal, within a certain tolerance, is the inductance characteristics center.

At block 812, a discharge path for an electrostatic discharge (ESD) received at the NFC loop antenna is provided by electrically connecting the inductance characteristics center of the NFC loop antenna to the electrical ground. By electrically connecting the inductance characteristics center of the conductive element of the NFC loop antenna to the electrical ground, the loop ground impedance representing the impedance from the ESD point of contact to the electrical ground through the inductance characteristics center is less than the NFC controller circuit ground impedance through the NFC controller circuitry for any point on the NFC loop antenna. The loop ground impedance is less at least in part due to the fact that there are no capacitors or other high impedance electrical components between the conductive element and electrical ground. Thus, the ESD pulse follows a discharge path to the electrical ground through the inductance characteristics center.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that utilizes a loop antenna to perform NFC communication. For example, an NFC-enabled laptop/computer, a tablet, a mobile phone, a point-of-sale system, a wearable electronic device, modems, routers, appliances, internet-of-things (IoT) devices, and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. An NFC communication device comprising:
NFC control circuitry, comprising an NFC controller and impedance matching circuitry;
an NFC loop antenna electrically connected to the NFC controller and the impedance matching circuitry; and
an electrical ground electrically connected to an inductance characteristics center of the NFC loop antenna, wherein the electrical ground provides a discharge path for an electrostatic discharge (ESD) received at the NFC loop antenna.

2. The NFC communication device of claim 1, wherein the NFC loop antenna comprises:
a conductive element comprising a first end terminating at a first feed point and a second end terminating at a second feed point.

3. The NFC communication device of claim 2, wherein a first inductance along the conductive element between the first feed point and the inductance characteristics center is substantially equivalent to a second inductance along the conductive element between the second feed point and the inductance characteristics center.

4. The NFC communication device of claim 2, wherein the first feed point is electrically connected to a first transmission line of the impedance matching circuitry, and the second feed point is electrically connected to a second transmission line of the impedance matching circuitry.

5. The NFC communication device of claim 4, wherein a loop ground impedance between any point on the NFC loop antenna and the electrical ground through the inductance characteristics center is less than an NFC control circuitry ground impedance between the point and the electrical ground through the NFC control circuitry.

6. The NFC communication device of claim 4, wherein the impedance matching circuitry comprises one or more electrical components configured to match the impedance of the NFC loop antenna.

7. The NFC communication device of claim 6, wherein the impedance matching circuitry further includes frequency filtering circuitry on the first transmission line and the second transmission line.

8. The NFC communication device of claim 7, wherein the frequency filtering circuitry comprises at least an inductor and a capacitor connected in series to the electrical ground.

9. The NFC communication device of claim 4, wherein the impedance matching circuitry further comprises:
a first receive line electrically connected to the first feed point and the NFC controller; and
a second receive line electrically connected to the second feed point and the NFC controller.

10. The NFC communication device of claim 1, wherein the inductance characteristics center of the NFC loop antenna is electrically connected to the electrical ground by a grounded pogo pin.

11. The NFC communication device of claim 1, wherein the inductance characteristics center of the NFC loop antenna is electrically connected to the electrical ground by a grounded screw.

12. The NFC communication device of claim 1, wherein the NFC communication device is configured to transmit and receive NFC signals.

13. A mobile electronic device, comprising:
a main board, comprising an electrical ground; and
an NFC communication device comprising:
NFC control circuitry, comprising an NFC controller and impedance matching circuitry; and
an NFC loop antenna electrically connected to the NFC controller and the impedance matching circuitry;
wherein the electrical ground is electrically connected to an inductance characteristics center of the NFC loop antenna, and wherein the electrical ground provides a discharge path for an electrostatic discharge (ESD) received at the NFC loop antenna.

14. The mobile electronic device of claim 13, wherein the NFC loop antenna comprises:
a conductive element comprising a first end terminating at a first feed point and a second end terminating at a second feed point.

15. The mobile electronic device of claim 14, wherein a first inductance along the conductive element between the first feed point and the inductance characteristics center is substantially equivalent to a second inductance along the conductive element between the second feed point and the inductance characteristics center.

16. The mobile electronic device of claim 14, wherein the first feed point is electrically connected to a first transmission line of the impedance matching circuitry, and the second feed point is electrically connected to a second transmission line of the impedance matching circuitry.

17. The mobile electronic device of claim 16, wherein a loop ground impedance between any point on the NFC loop antenna and the electrical ground through the inductance characteristics center is less than an NFC control circuitry ground impedance between the point and the electrical ground through the NFC control circuitry.

18. The mobile electronic device of claim 13, the main board further comprising a grounded pogo pin electrically connected to the electrical ground, wherein the inductance characteristics center of the NFC loop antenna is electrically connected to the electrical ground by the grounded pogo pin.

19. The mobile electronic device of claim 13, the main board further comprising a grounded screw electrically connected to the electrical ground, wherein the inductance characteristics center of the NFC loop antenna is electrically connected to the electrical ground by the grounded screw.

20. A method of manufacturing an NFC communication device, the method comprising:
providing NFC control circuitry, comprising an NFC controller and impedance matching circuitry;
providing an NFC loop antenna;
electrically connecting the NFC loop antenna to the NFC controller and the impedance matching circuitry;
providing an electrical ground;
determining an inductance characteristics center of the NFC loop antenna; and
providing a discharge path for an electrostatic discharge (ESD) received at the NFC loop antenna, by electrically connecting the inductance characteristics center of the NFC loop antenna to the electrical ground.
